(19) United States
(12) Patent Application Publication
(10) Pub. No.: US 2015/0336036 A1
(43) Pub. Date: Nov. 26, 2015

(54) FILTER CLOTH RETENTION

(71) Applicant: CLEAR EDGE-GERMANY GMBH, Geldern-Walbeck (DE)

(72) Inventors: Shireesh Pankaj, Geldern (DE); Ian Colin Chisem, Warrington (GB); David Michael Fogg, Rossendale Lancashire (GB)

(21) Appl. No.: 14/759,407

(22) PCT Filed: Jan. 7, 2014
(86) PCT No.: PCT/EP2014/050175

§ 371 Date: Jul. 6, 2015

(30) Foreign Application Priority Data
Jan. 7, 2013 (GB) 1300218.3

(51) Int. Cl. B01D 33/80; F16B 2/08; F16B 11/00; B01D 33/067

(52) U.S. Cl. CPC B01D 33/80; B01D 33/067; F16B 2/08; F16B 11/006; F16B 11/00

(57) ABSTRACT

An apparatus for retaining filter cloths (11) on a drum filter comprising a body (14) provided on the side of the filter cloth aperture to face the inside of the drum. The body is received in a recess in the drum. The apparatus further comprises a resilient element (18) to be located on the remote side of the cloth (11) to the body (14) for urging the body (14) into the recess.

The present invention relates to an apparatus for retaining filter cloths, particularly, but not exclusively, for use in drum filters. One possible application of the apparatus of the invention is in centrifuge drum filters.

Centrifuge drum filters comprise a drum filter basket. A filter cloth is provided on the inside of the drum basket. The filter cloth is made endless by means such as sewing or welding, including end to end welding. In one known arrangement two or more ringed metal bands are used to hold the filter cloth in place. Each ring is made from a length of solid metal with a hole provided at each end. These holes may be engaged by a closing tool to help bring the ends together. The two ends are then secured together by a ratchet hook mechanism, complementary parts of the mechanism being provided at the respective ends of the metal band. In operation, as the filter drum rotates centrifugal force causes the ratchet to expand within the confines of the drum thus securing the filter fabric in place by clamping it between the ring and the drum. In general, at least two metal solid metal bands are provided to secure the filter cloth in place, one at each edge of the drum. A recess is provided at each end of the drum in order to receive a band.

These known clamping rings are prone to damage and are vulnerable to failure. Breakdown of the clamping system leads to considerable downtime of the drum filter and a relatively long filter cloth replacement fitting time.

Furthermore these known clamping rings are themselves expensive and are not easy to install. Centrifugal drum filters are often used in the pharmaceutical industry. During one filtration cycle the material produced may be worth, say, Eur 100,000. If the pharmaceutical material located on the filter is contaminated as a result of the breakdown the failure may prove very expensive indeed.

The present invention has been made from a consideration of this.

According to a first aspect of the present invention there is provided an apparatus for retaining filter cloths on a drum filter, the drum filter having a recess therein, wherein the apparatus comprises a body provided on the side of the filter cloth, or material connected to the filter cloth, the body being operative to face the inside of the drum, the body being receivable in the recess, the apparatus further comprising a resilient element to be located on the remote side of the cloth (or material) to the body, the resilient element being operative to urge the body into the recess.

According to a second aspect of the present invention there is provided a kit apparatus for retaining filter cloths on a drum filter, the drum filter having a recess therein, where the kit apparatus comprises a filter cloth, a body and a resilient element, wherein in use the body is provided on the side of the filter cloth, or material connected to the filter cloth, the body being receivable in the recess, the resilient element being located on the remote side of the cloth (or material) to the body, the resilient body being operative to urge the body into the recess.

The filter retention apparatus of the invention provides a durable and reliable means of securing a filter cloth in place in a drum filter. The apparatus is easy and quick to fit resulting in reduced filtration downtime.

In one embodiment the resilient element is a band. The band is ideally endless. A metal band, such as a spring stainless steel or hastelloy alloy band is used in one embodiment of the invention.

The resilient element may be positioned in a channel of a moulding located on the filter cloth. The moulding may comprise any polymeric material, elastomeric material or composite material or blend of any of the aforesaid, but is ideally made of elastomeric material, such as thermoplastic elastomer. The moulding and body may be in one piece.

The elastomer may comprise any of rubber and polypropylene. In one embodiment of the invention a cross linked mixture of EPDM rubber and polypropylene is used, such as that marketed under the registered trade mark SANTOPRENE.

In a further embodiment, the resilient element has a limited range of circumferential size adjustment. This adjustment should be capable of being made at the time of fitting into the centrifuge drum.

The moulding and/or body may be non-continuous. There may be a butt-joint where the two ends of the moulding and/or body meet. In one embodiment, the two ends of the moulding and/or body may simply be held in place through the action of the resilient member.

In alternative embodiments, the two ends of the moulding and/or body may be sealed together. The two ends may be adhered using means such as gluing or welding. In the same or further embodiments, the joint between the two ends may be inclined. In such embodiments, the abutting ends may be angled relative to each other. The joint may be inclined at an angle of from around 40° to around 50°, preferably around 45°. Some embodiments may comprise a combination of the adhering together of the two ends and/or the inclination of the joint. The aforementioned techniques can improve the seal between the two ends and prevent particle ingress through the joint.

In order that the present invention may be more readily understood specific embodiments thereof will be described with reference to the accompanying drawings in which: —

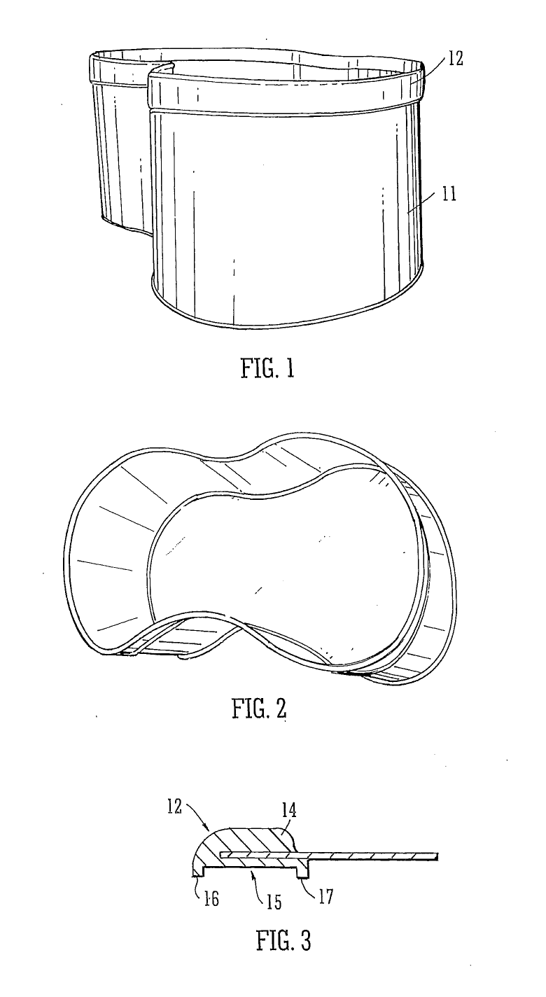

FIG. 1 is a perspective view of a filter cloth for use in a drum filter;

FIG. 2 is a top view of the filter cloth of FIG. 1;

FIG. 3 is a diagrammatic cross-sectional illustration of one edge of the filter cloth shown in FIGS. 1 and 2;

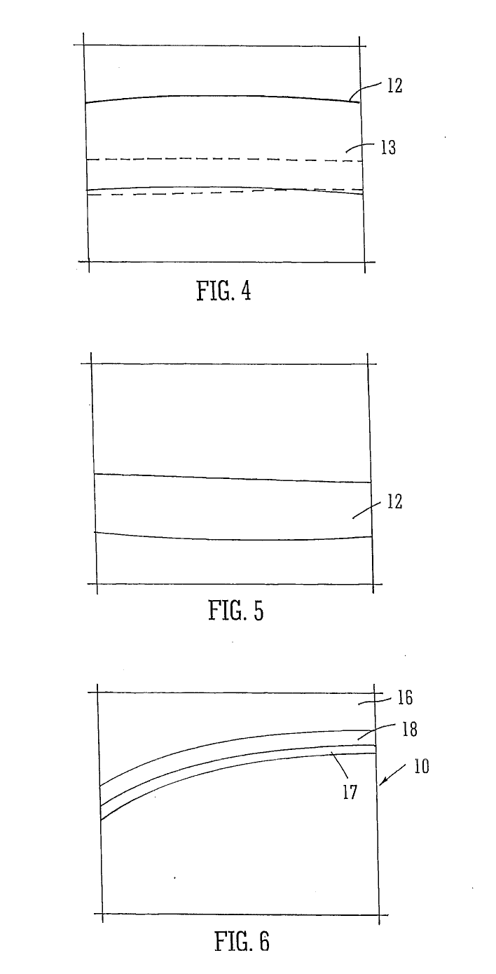

FIG. 4 shows, in part, the rear side view of one edge of the filter cloth shown in FIGS. 1 to 3;

FIG. 5 shows, in part, the front view of the edge illustrated in FIG. 4;

FIG. 6 shows, in part, one embodiment of the apparatus of the invention comprising the arrangements shown in FIGS. 1 to 5 in combination with a band;

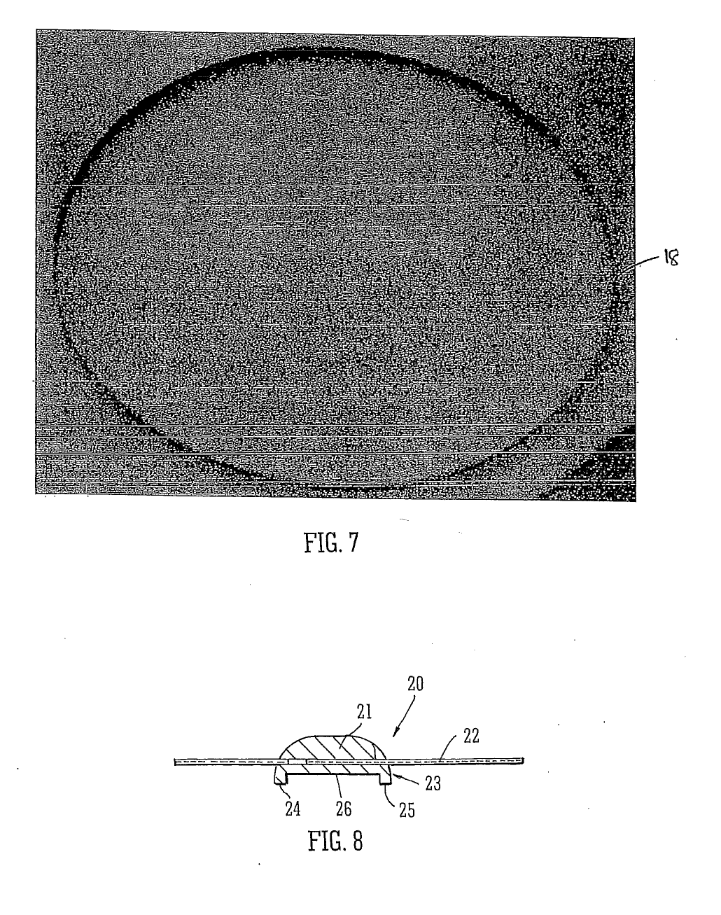

FIG. 7 shows the band as used in the embodiment of the invention illustrated in FIG. 6;

FIG. 8 is a further embodiment of the invention;

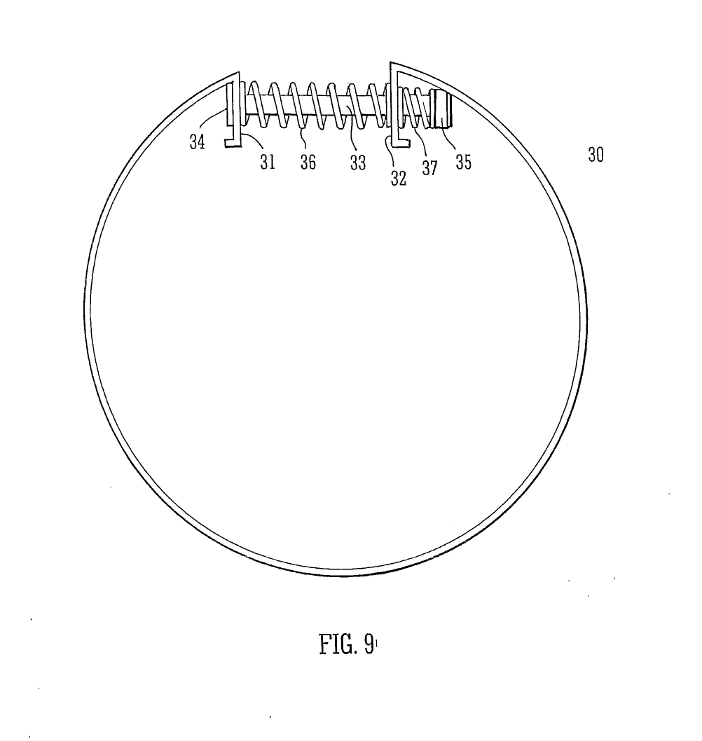

FIGS. 9 to 14 show alternative bands to that shown in FIG. 7; and

FIG. 15 shows a sleeve for use in combination with the arrangement of any of FIGS. 9-14.

Referring to the drawings a filter cloth 11 for use in a centrifuge filter drum is made endless in conventional fashion by hot air welding or otherwise is extruded directly. The edges of the filter cloth 11 are then encased in a moulding 12 of elastomeric material as is best shown in FIG. 3. The elastomeric material is then secured to the cloth by stitching 13 as shown in FIG. 4 and/or by other joining methods such as welding. It is noted that the cloth can be made endless by other means such as overlap welding and stitching.

The elastomeric moulding 12 is such that a body 14 of material is provided on the side of the filter cloth which in use contacts the inside of the filter drum basket. Each body 14 is complementary to a recess provided around the inside of the drum at its edge such that the bodies are received in their respective recesses with a snug fit. The two opposing ends of the moulding (not shown) can be joined to form a butt-joint. The joint may be held in place through the action of the band 18. Alternatively, the two opposing ends of the moulding may be sealed together by gluing or welding. The two ends of the moulding can be angled relative to each other such that the joint where they meet can be inclined, preferably inclined at an angle of from 40° to 50°, such as for example 45°.

The elastomeric moulding further comprises a channel 15 defined by a pair of projections 16, 17. The channel 15 is dimensioned so as to receive a resilient snap-fit material, such as stainless steel, endless band 18 as shown in FIGS. 6 and 7. Bands such as those disclosed in EP0751814 are suitable.

In use the filter cloth arrangement shown in FIGS. 1 and 2 is located inside the basket of the filter drum such that the bodies 14 of the elastomeric material are in register with the channels (not shown) extending around the filter basket.

A band of resilient stainless steel 18 is then located in the channel 15 of each moulding 12 so as to maintain the filter cloth 11 in place.

For particularly wide filter cloths it is possible to locate one or more additional fixings intermediate the two edge mouldings illustrated in FIG. 1. Such an arrangement 20 is illustrated in cross-section in FIG. 8.

Referring to FIG. 8 a body 21 of elastomeric material is secured to the central section of an endless filter cloth 22 for use in a drum filter. In use this is received with a snug fit in a complementary endless recess (not shown) provided in the filter drum basket. A moulding 23 of elastomeric material is provided on the opposite side of the filter fabric 22 in register with the aforesaid body 21. This moulding 23 has two projections 24, 25 defining a channel 26 therebetween. In use an endless resilient stainless steel band as illustrated in FIG. 7 is received in the channel 26 so as to urge the body 21 into the recess in the filter drum basket thus securing the filter cloth 22 in place.

FIGS. 9 to 13 show alternative embodiments of bands for use in place of the band shown in FIG. 7. Particularly with larger diameter drums, the tolerance of the spring band is small in order to obtain a good snap fit, such as ±0.5 mm in a band of 300-500 mm circumference. Hence it may in some circumstances be useful to include a limited range of adjustment in the spring band. In principle this could be set only once at the time of first fitting. Subsequent renewal and refitting of the same cloth and band in the same centrifuge drum would not require readjustment.

In FIG. 9 an open ring 30 of steel terminates with flanges 31, 32. A rod 33 has heads 34, 35 at each of its ends. The rod 33 passes through aligned apertures (not shown) in the flanges 31, 32. One head 34 abuts the first side of the first flange 31. A relatively strong helical spring 36 is captured on the rod between the two flanges 31, 32. A further relatively less strong spring 37 is captured on the rod between the second flange 32 and the second head 35.

The assembly comprising the rod, flanges and springs may be covered by a hollow sleeve, as shown in FIG. 15. When located in position the arrangement provides for automatic adjustment in the spring band circumference.

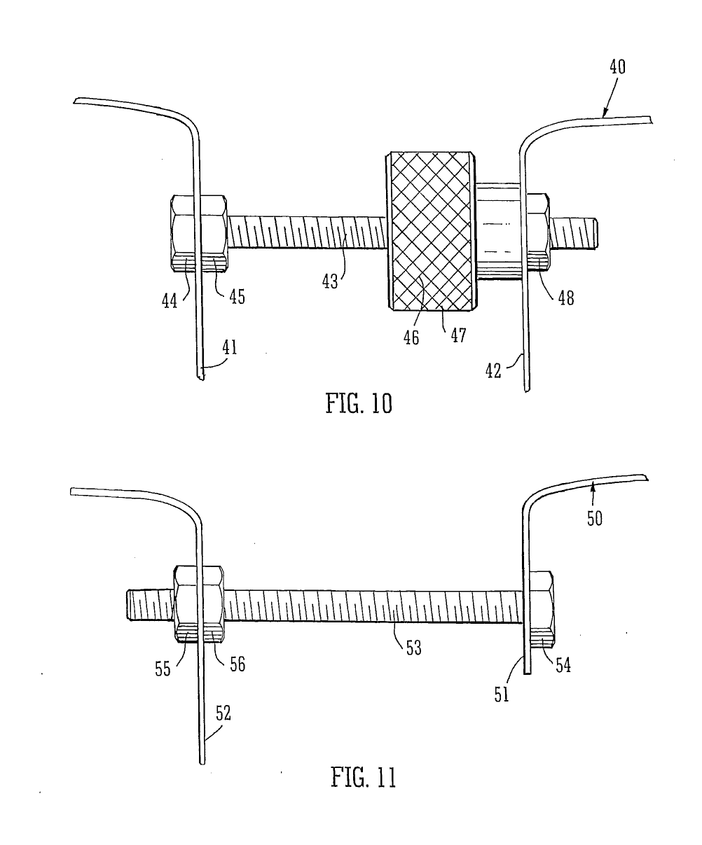

In FIG. 10 an open ring 40 of steel terminates with flanges 41, 42. A threaded bolt 43 having a head 44 at one end extends through aligned apertures in the flanges 41, 42. A first nut 45 is tightened on the bolt thread so as to capture the first flange 41 between the head 44 and the nut 45. An adjuster nut 46 having an enlarged segment 47 for ease of adjustment is provided between the flanges 41, 42 and a second nut 48 is provided at the outside of the second flange 42.

The diameter of the ring 40 may be adjusted by adjusting the space between the two flanges 41, 42 by means of moving the adjuster nut 46 and second nut 48.

In FIG. 11 an open ring 50 of spring steel terminates in two flanges 51, 52. A threaded bolt 53 having a head 54 passes through aligned apertures in the flanges 51, 52. The head 54 abuts the first flange 51. The second flange 52 is captured between two nuts 55, 56.

The diameter of the ring 50 may be adjusted by adjusting the space between the two flanges 51, 52 by means of moving the two nuts 55, 56 along the bolt.

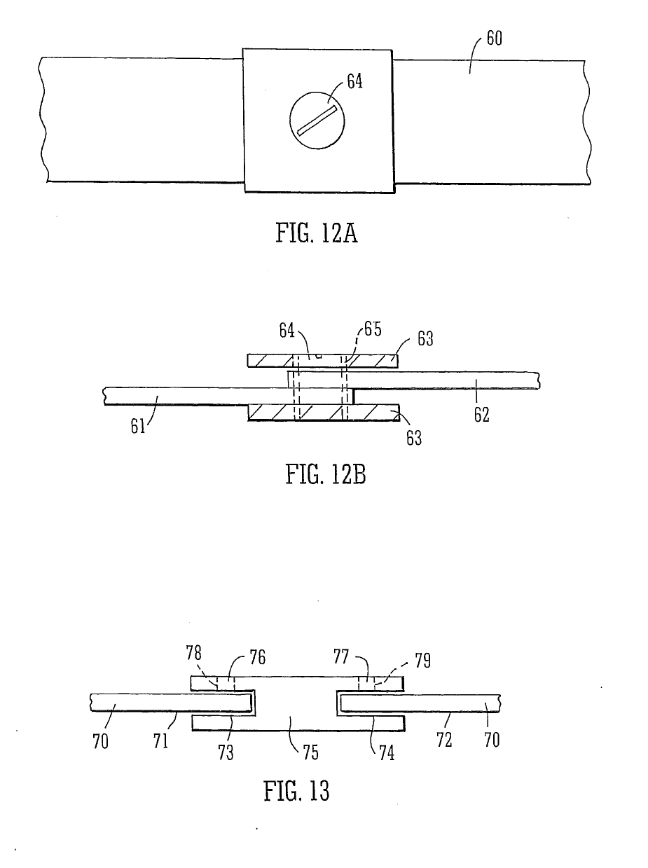

Referring the FIGS. 12a and 12b two ends 61, 62 of an open steel ring 60 are fed into a metal block 63 and clamped together by way of an adjustable flat screw 64 within a threaded aperture 65 at the top of the block 63. As the screw 64 is screwed into the block 63 the two ends 61, 62 of the ring are clamped and captured between the end of the screw 64 and the base of the block 63. Adjustment of the diameter of the ring may be made by adjusting the extent of overlap of the two ends 61, 62 of the ring 60.

In FIG. 13 the two ends 71, 72 of an open ring 70 of steel are each received in a channel 73, 74 is a so-called adjuster block 75. A flat screw 76, 77 is received in a threaded hole 78, 79 above each channel 73, 74. As the flat screw 76, 77 is screwed into the hole 78, 79 it engages the top of the end 71, 72 of the metal ring 70 and clamps the end 71, 72 in place between the base of the screw 76, 77 and the base of the channel 73, 74.

Adjustment of the ring size is achieved by interchanging the adjuster block 75 with a similar adjuster block having a different length.

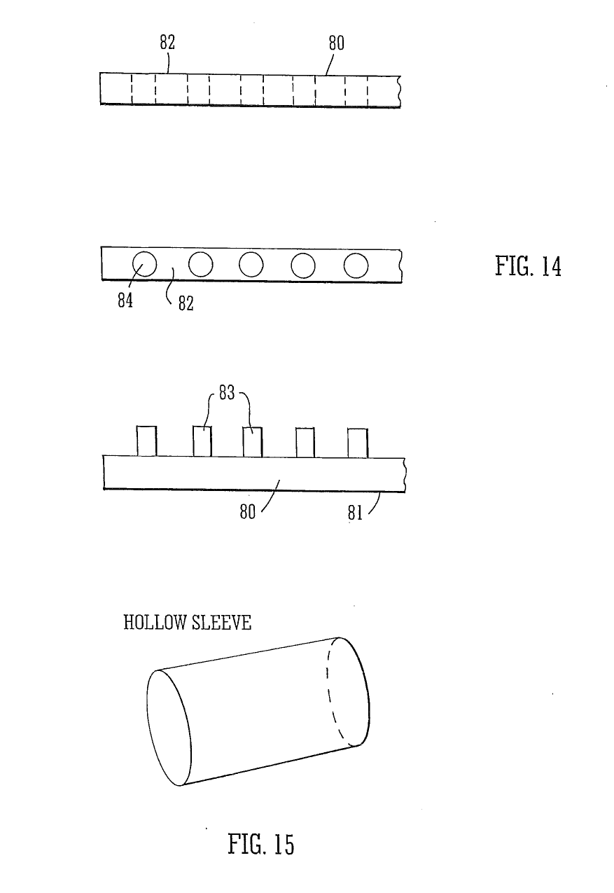

Referring to FIG. 14 one end 81 of a metal band 80 is provided with a series of projections 83 of similar shape to the apertures 84 provided in the other end 82 of the metal band 80 such that the projections 83 may be inserted in the apertures 84 and captured therein, in like manner to an adjustable sized baseball hat.

The diameter of the ring may be adjusted by moving the two ends of the ring 81, 82 relative to each other so that more or fewer of the projections 83 overlap with the apertures 84 prior to engagement of the projections 83 in the apertures 84.

FIG. 15 shows a sleeve which may be located over the fixing arrangements of the bands shown in FIGS. 9-14.

It is to be understood that the above described embodiment is by way of illustration only. Many modifications and variations are possible. For example, the bodies 14, 21 need not necessarily be adhered to the filter cloth. This is optional.

In one embodiment the body is not permanently fixed to the cloth.

The resilient element may be coated so that it may be made from any material such as steel which is not stainless steel.

The resilient element may be integrated into the apparatus rather than being a separate piece.

1-19. (canceled)

20. An apparatus for retaining filter cloths of a drum filter, the drum filter having a recess therein, wherein the apparatus comprises a body provided on the side of the filter cloth, or material connected to the filter cloth, the body being operative to face the inside of the drum, the body being receivable in the recess, the apparatus further comprising a resilient element to be located on the remote side of the cloth (or material) to the body, the resilient element being operative to urge the body into the recess.

21. An apparatus as claimed in claim 20, wherein the resilient element is a metallic band.

22. An apparatus as claimed in claim 21, wherein the band is made from stainless steel, alloy or a coated metal.

23. An apparatus as claimed in claim 20, wherein the body comprises a polymeric material, elastomeric material, composite material, or a blend comprising any of the aforesaid materials.

24. An apparatus as claimed in claim 20, wherein the body is moulded.

25. An apparatus as claimed in claim 20, wherein the body comprises any of rubber, polypropylene or a cross-linked mixture thereof.

26. An apparatus as claimed in claim 20, wherein the resilient element has a limited range of circumferential size adjustment.

27. An apparatus as claimed in claim 20, wherein the body is provided directly on the filter cloth.

28. An apparatus as claimed in claim 20, where the body is provided on a web, the web being fixed to the filter cloth.

29. An apparatus as claimed in claim 20, wherein the body is permanently fixed in position, optionally by welding, adhesive or sewing.

30. An apparatus as claimed in claim 20, wherein the body is not permanently fixed in position.

31. An apparatus as claimed in claim 20, wherein the resilient element is permanently secured in position, optionally by welding, adhesive or sewing.

32. An apparatus as claimed in claim 20, wherein the resilient element is not permanently secured in position.

33. An apparatus as claimed in claim 20, wherein the two ends of the body meet to form a butt-joint.

34. An apparatus as claimed in claim 33, wherein the butt-joint is held in place through the action of the resilient element.

35. An apparatus as claimed in claim 20, wherein the two ends of the body are sealed together, optionally by gluing or welding.

36. An apparatus as claimed in claim 20, wherein the two ends of the body meet to form an inclined joint, in which the abutting ends are angled relative to each other.

37. An apparatus as claimed in claim 36, wherein the joint is inclined at an angle of from 40° to 50°, optionally 45°.

38. A kit apparatus for retaining filter cloths on a drum filter, the drum filter having a recess therein, where the kit apparatus comprises a filter cloth, a body and a resilient element, wherein in use the body is provided on the side of the filter cloth, or material connected to the filter cloth, the body being receivable in the recess, the resilient element being located on the remote side of the cloth (or material) to the body, the resilient body being operative to urge the body into the recess.
